(19) United States
(12) Patent Application Publication
(10) Pub. No.: US 2007/0049154 A1
(43) Pub. Date: Mar. 1, 2007

(54) Method of fabricating field emission display device and cathode plate thereof

(76) Inventors: Yu-Yang Chang, Jhudong Township (TW); Wei-Yi Lin, Tuku Township (TW); Kwan-Sin Ho, Toufen Township (TW); Te-Hao Tsou, Longtan Township (TW)

Correspondence Address: J C PATENTS, INC., 4 VENTURE, SUITE 250, IRVINE, CA, 92618, US

(21) Appl. No.: 11/223,498

(22) Filed: Sep. 8, 2005

(30) Foreign Application Priority Data
Aug. 25, 2005 (TW) 94129056

(51) Int. Cl. H01J 9/00

(52) U.S. Cl. 445/24

(57) ABSTRACT

A method of fabricating a field emission display device and a cathode plate thereof is provided. By using a sandblasting process, an electrode layer on the cathode plate is patterned and a portion of the substrate fogged up to produce light diffusion effects. Since the electrodes and the light diffusion layer are formed in the same step, the process of fabricating the cathode plate is simplified.

### CROSS-REFERENCE TO RELATED APPLICATION

This application claims the priority benefit of Taiwan application serial no. 94129056, filed on Aug. 25, 2005. All disclosure of the Taiwan application is incorporated herein by reference.

### BACKGROUND OF THE INVENTION

1. Field of the Invention

The present invention relates to a method of fabricating a cathode plate. More particularly, the present invention relates to a method of fabricating a field emission display device and a cathode plate thereof.

2. Description of the Related Art

For the field emission display device, electrons in the sharp points of a material layer on the cathode plate are attracted by the electric field under the vacuum environment and thus leave the cathode plate. Due to the positive voltage of the anode, the field emission electrons leaving the cathode plate are accelerated towards the anode and then impacts with the fluorescent powders on the anode plate to produce light. Conventionally, the cathode plate serves as an emission source for field electrons and the anode plate serves as a light source. FIG. 1 is a schematic cross-sectional view of a conventional field emission display device. As shown in FIG. 1, the electrons emitted from the cathode plate 10 bombard the fluorescent layers 201 on the anode plate 20 to produce light. In general, the display device employing this type of light source as the back light source will use the surface close to the anode plate as a light-receiving surface. However, for this type of light emission scheme, electrons bombarding the fluorescent powders may produce considerable amounts of heat in the anode plate. Hence, the working life of the display device may be reduced and the optical performance of the device may be compromised as well.

Additionally, the field emission display device, when used as the back light source for other devices, is a flat panel light emission device having an illumination more homogeneous than the cold cathode fluorescent lamp (CCFL) or the light-emitting diode (LED). However, under the ever-increasing demand for uniform illumination of a display device, a diffuser or a brightness-enhancing film (BEF) is still needed to improve the uniformity of the illumination and increase brightness for the field emission display device. Consequently, the manufacture of the field emission display device becomes more complex and a higher production cost is required. It is a big drawback in the production of the field emission device on a large scale for securing a higher market share.

### SUMMARY OF THE INVENTION

Accordingly, at least one objective of the present invention is to provide a field emission display device and a cathode plate thereof, which integrates the conventional processes of fabricating the light diffusion layer (diffuser) on the cathode plate and fabricating the conductive electrode layer together. Hence, the light diffusion layer is simultaneously formed as the conductive electrode layer is fabricated on the cathode plate. In other words, there is no need to set aside additional steps for forming the light diffusion layer. Ultimately, the processing steps are simplified, and yet, a field emission display device with a uniform light diffusion is obtained.

At least another objective of the present invention is to provide a method of fabricating a field emission display device and a cathode plate thereof, using the same step for patterning the conductive electrode layer and the emission layer on cathode plate and forming a light diffusion layer on the cathode plate simultaneously.

At least another of the present invention is to provide a method of fabricating a field emission display device, comprising forming a cathode plate and an anode plate, providing a plurality of supporters, disposing the supporters between the cathode plate and the anode plate and attaching the ends of the supporters to the cathode plate and the anode plate respectively. Hence, a completely assembled field emission display device is formed.

To achieve these and other advantages and in accordance with the purpose of the invention, as embodied and broadly described herein, the invention provides a method of forming a cathode plate comprising the following steps. First, a substrate is provided. Then, an electrode layer is formed to cover the substrate. Thereafter, a patterned photoresist layer is formed over the electrode layer. Using the patterned photoresist layer as a mask, the electrode layer is sandblasted to pattern the electrode layer and haze the exposed portion of the substrate. Afterwards, the patterned photoresist layer is removed to expose the patterned electrode layer and an emission layer is formed to cover the patterned electrode layer.

According to another embodiment of the present invention, the method of forming the cathode plate includes the following steps. First, a substrate is provided. Then, an electrode layer is formed to cover the substrate. Thereafter, an emission layer is formed to cover the electrode layer. A patterned photoresist layer is formed over the emission layer. Using the patterned photoresist layer as a mask, the electrode layer and the emission layer are sandblasted to pattern the electrode layer and the emission layer simultaneously and haze an exposed portion of the substrate. Finally, the patterned photoresist layer is removed to expose the patterned electrode layer and the patterned emission layer.

According to one embodiment of the present invention, the step of forming the emission layer on the electrode layer includes churning the synthesized carbon nanotube material into a paste and coating a carbon nanotube layer on the electrode layer using the carbon nanotube material in a screen-printing process. According to yet another embodiment of the present invention, the step of forming the emission layer over the electrode layer includes directly forming a carbon nanotube layer over the electrode layer.

According to one embodiment of the present invention, the step of sandblasting the electrode layer and the emission layer includes sandblasting the electrode layer and the emission layer using aluminum oxide particles.

The present invention also provides another method of forming a cathode plate, the method includes the following steps. The cathode plate is suitable for serving as the back light source of a field emission display device. First, an electrode layer is formed to cover a substrate. Then, a patterned photoresist layer is formed over the electrode layer. Using the patterned photoresist layer as a mask, the electrode layer is sandblasted to pattern the electrode layer into a plurality of cathode structures and a plurality of gate structures and then an emission layer that covers the patterned electrode layer is formed.

The present invention also provides a method of forming a cathode plate suitable for serving as the back light source of a field emission display device. The method includes the following steps. First, an electrode layer is formed to cover a substrate. Then, an emission layer is formed to cover the electrode layer. Thereafter, a patterned photoresist layer is formed over the emission layer. Using the patterned photoresist layer as a mask, the electrode layer and the emission layer are sandblasted to pattern the electrode layer and the emission layer simultaneously and haze a portion of the exposed substrate. The process of patterning the electrode layer forms a plurality of cathode structures and a plurality of gate structures. Furthermore, the patterned emission layer covers over the cathode structures.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a conventional field emission display device.

FIG. 2 is a schematic cross-sectional view of a reflective type field emission display device according to the present invention.

FIGS. 3A through 3F are schematic cross-sectional views showing the steps for forming a field emission display device and its cathode plate according to one embodiment of the present invention.

FIGS. 4A through 4F are schematic cross-sectional views showing the steps for forming a field emission display device and its cathode plate according to another embodiment of the present invention.

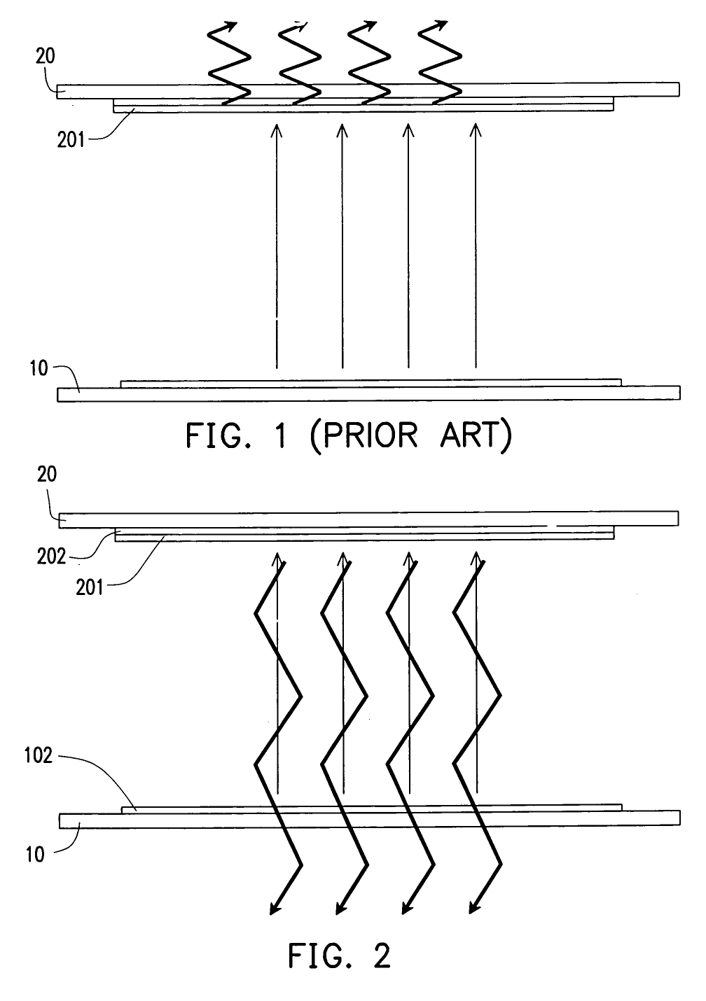

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

When a field emission display device is used as a back light source for other display devices, a reflective type back light source having a metallic conductive reflective layer formed on an anode plate is provided in the present invention to avoid over-heating problems. FIG. 2 is a schematic cross-sectional view of a reflective type field emission display device according to the present invention. The electrons emitted from the (electron) emission layer 102 of a cathode plate 10 bombard against a fluorescent layer 201 on an anode plate 20 to emit light. However, the metallic conductive reflection layer 202 on the anode plate 20 will reflect light. The reflected light penetrates the cathode plate 10 and emerges from another face 10a of the cathode plate 10. Therefore, when the field emission display device is used as a back light source, the display device is disposed close to the cathode plate so that the surface close to the cathode plate surface 10a is a light-receiving surface.

Because the reflected light needs to penetrate through the cathode plate, the electrode layer and the gate layer of the cathode plate are designed to be the same layer and the electrode structures and the gate structures are formed by performing a single etching operation. For example, the electrode structure of the cathode plate and the gate structure are strip structures parallel to one another for light transmission. Thus, the efficiency of the light emission is increased and the over-heating problem is minimized.

The present invention provides a method of forming a field emission display device and its cathode plate. In the process of fabricating the cathode plate, no extra step is required to form the light diffusion layer. Moreover, by performing a sandblasting operation, the electrode layer is patterned and at the same time a portion of the substrate becomes hazy for light diffusion.

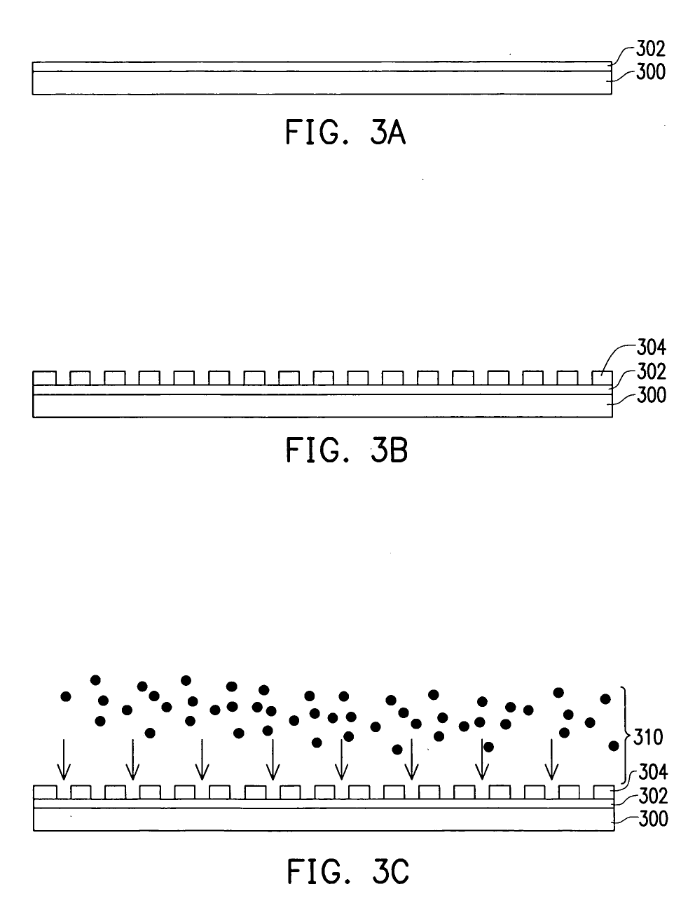

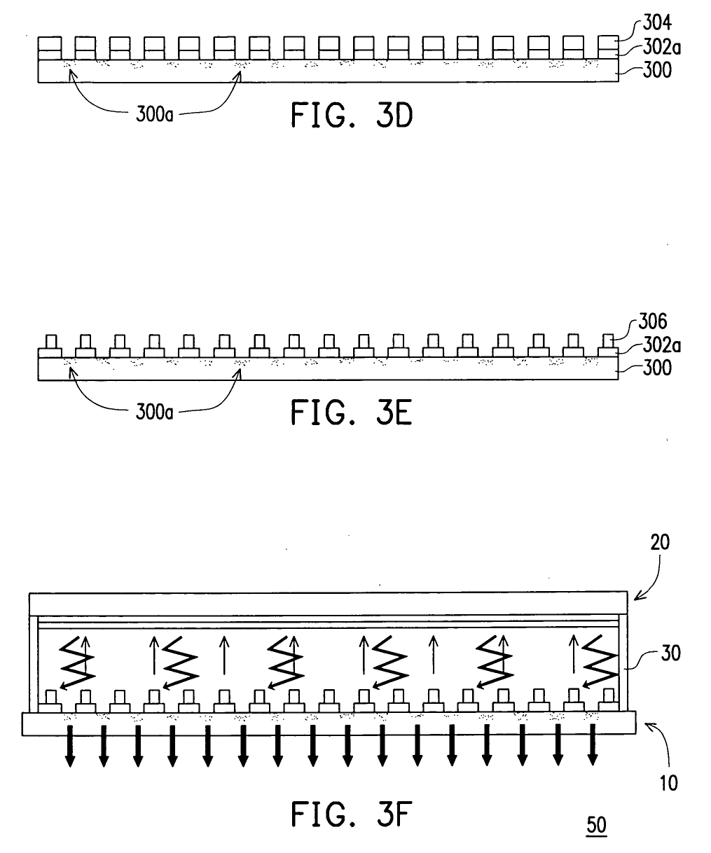

FIGS. 3A through 3F are schematic cross-sectional views showing the steps for forming a field emission display device and its cathode plate according to one embodiment of the present invention. First, as shown in FIG. 3A, a substrate 300 is provided. The substrate 300 is fabricated using glass, for example. When the field emission display device is used as a back light source, for example, in the fabrication of a 20-inch panel, a 20-inch (370 mm×470 mm×2.8 mm) glass is used as the bottom substrate. An electrode layer 302 is formed on the substrate 300. For example, the electrode layer 302 is coated on the substrate 300 by a screen-printing operation. The electrode layer is a metal layer, for example, a silver electrode layer having a thickness of about 5˜10 μm.

As shown in FIG. 3B, a photoresist layer 304 is formed on the electrode layer. Then, after exposure and development, the photoresist layer 304 is patterned. The photoresist layer 304 has a thickness of about 2˜10 μm, for example.

As shown in FIGS. 3C and 3D, using the patterned photoresist layer 304 as a mask, a sandblasting operation 310 is carried out to remove a portion of the electrode layer 302. The electrode layer that needs to be retained is protected by the patterned photoresist layer 304, while the unprotected portion of the electrode layer 302 is abraded by the sand particles until the substrate 300 is exposed. Hence, a patterned electrode layer 302a is formed. In the meantime, an exposed portion of the substrate 300 is also fogged up (sandblasted to become translucent or hazy) by the particles used in the sandblasting operation 310. That exposed portion of the substrate 300a that is hazed by the sandblasting operation can be regarded as a light diffusion layer. The sandblasting operation 310 uses aluminum oxide (Al₂O₃) particles to perform the fogging treatment and the aluminum oxide particles used in the sandblasting operation have a size between about 17˜25 μm, for example.

As shown in FIG. 3E, the patterned photoresist layer 304 is removed. Then, an emission layer 306 is formed on the patterned electrode layer 302a. The emission layer 306 is, for example, a carbon nanotube (CNT) layer having a thickness of about 10˜15 μm. The CNT layer can be fabricated, for example, by using arc evaporation, graphite laser ablation or the chemical vapor deposition (CVD) process. The emission layer 306 is formed, for example, using the aforementioned process to form the carbon nanotube (CNT), transforming the CNT material into a paste and then screen-printing the CNT paste on the patterned electrode layer 302a to form the CNT layer. Alternatively, a catalyst is formed on the patterned electrode layer 302a so that a CNT layer can be directly formed on the electrode layer. At this point, the cathode plate 10 is completely fabricated.

After forming the cathode plate 10, an anode plate 20 and a plurality of supporters 30 are provided as shown in FIG. 3F. The supporters 30 are disposed between the cathode plate 10 and the anode plate 20 and the ends of the supports 30 are attached to the cathode plate 10 and the anode plate 20 to form a complete field emission display device 50.

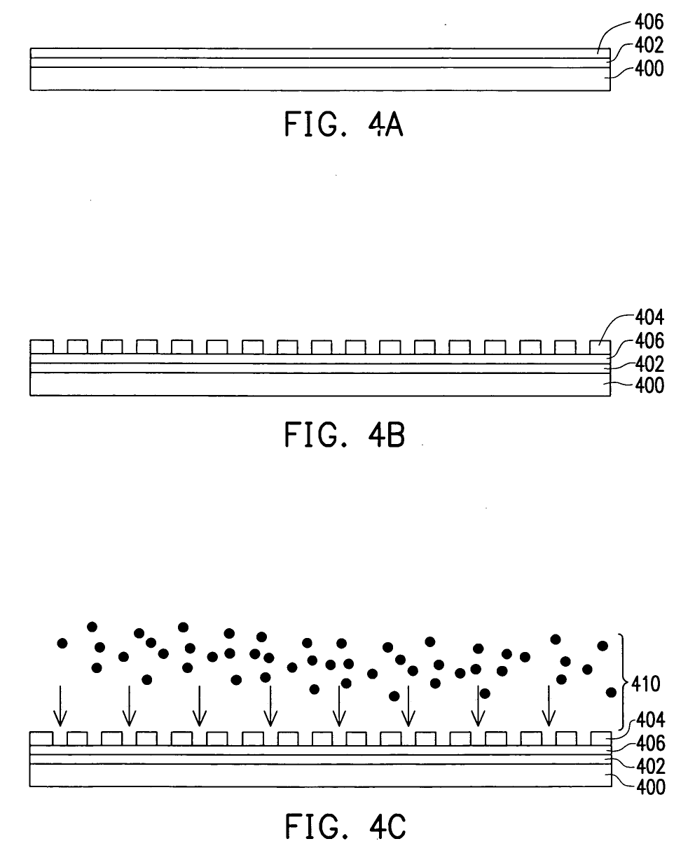

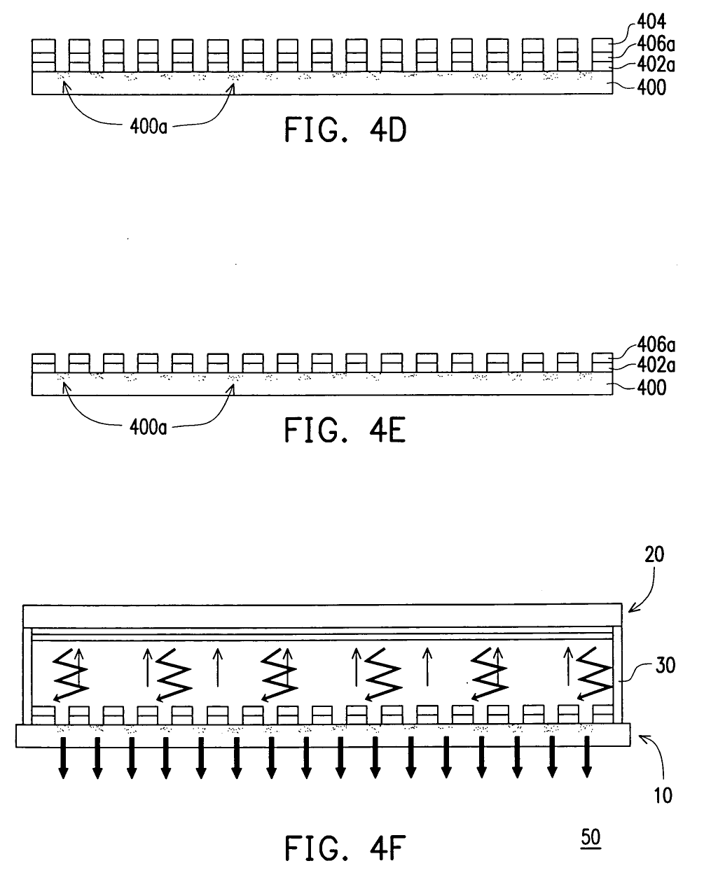

FIGS. 4A through 4F are schematic cross-sectional views showing the steps for forming a field emission display device and its cathode plate according to another embodiment of the present invention. First, as shown in FIG. 4A, a substrate 400 is provided. The substrate 400 is fabricated using glass, for example. Then, an electrode layer 402 and an emission layer 406 are formed in sequence over the substrate 400. For example, the electrode layer 402 is formed on the substrate 400 by a screen-printing process. Moreover, the electrode layer 402 is a metal layer, for example, a silver electrode layer having a thickness of about 5˜10 μm. The emission layer 406 is, for example, a carbon nanotube (CNT) layer having a thickness of about 10˜15 μm. The CNT material can be fabricated by arc evaporation, graphite laser ablation or chemical vapor deposition. The method of forming the emission layer 406 includes churning the aforementioned CNT material into a paste and coating the paste on the electrode layer 402 by a screen-printing process. Alternatively, a catalyst is formed on the electrode layer 402 and then the CNT layer is directly formed on the electrode layer 402.

As shown in FIG. 4B, a photoresist layer 404 is formed over the electrode layer. Then, after exposure and development, the photoresist layer 404 is patterned. The photoresist layer 404 has a thickness of about 2˜10 μm.

As shown in FIGS. 4C and 4D, using the patterned photoresist layer 404 as a mask, a sandblasting operation 410 is carried out to remove a portion of the electrode layer 402 and a portion of the emission layer 406. The electrode layer 402 and the emission layer 406 that need to be retained are protected by the patterned photoresist layer 404 while the unprotected electrode layer 402 and the unprotected emission layer 406 are abraded by particles until the substrate 400 is exposed. Hence, a patterned electrode layer 402a and a patterned emission layer 406a are formed. In the meantime, the exposed portion of the substrate 400 is also fogged up by the sandblasting particles. The translucent portion of the substrate 400a produced by the sandblasting operation can be regarded as a light diffusion layer. The sandblasting operation 410 uses aluminum oxide (Al₂O₃) particles to perform the fogging treatment and the aluminum oxide particles used in the sandblasting operation have a size between about 17˜25 μm, for example.

As shown in FIG. 4E, the patterned photoresist layer 404 is removed to expose the patterned emission layer 406a and the patterned electrode layer 402a underneath. Up to this point, the fabrication of the cathode plate 10 is complete.

After forming the cathode plate 10, an anode plate 20 and a plurality of supporters 30 are provided as shown in FIG. 4F. The supporters 30 are disposed between the cathode plate 10 and the anode plate 20 and the ends of the supports are attached to the cathode plate and the anode plate to form a complete field emission display device 50.

According the method of forming the cathode plate in the present invention, the sandblasting operation for hazing the glass is used to pattern the electrode layer and/or the emission layer, so that the electrode layer and/or the emission layer are patterned without performing extra etching steps. Through simultaneously patterning the electrode layer and/or the emission layer along with fogging up a portion of the substrate by the sandblasting operation, it not only enhances light diffusion effects but also reduces the extra costs for fabricating the diffuser. Furthermore, it simplifies the fabrication processes and reduces the production costs for the cathode plate. Moreover, the misalignment in the screen-printing process is significantly reduced and overall reliability of the device is increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of forming a field emission display device, comprising the steps of:
forming a cathode plate comprising the following steps:
providing a substrate;
forming an electrode layer over the substrate;
forming a photoresist layer over the electrode layer;
patterning the photoresist layer;
sandblasting the electrode layer using the patterned photoresist layer as a mask to pattern the electrode layer and fog up an exposed portion of the substrate;
removing the patterned photoresist layer to expose the patterned electrode layer; and
forming an emission layer to cover the patterned electrode layer;
forming an anode plate;
providing a plurality of supporters; and
disposing the supporters between the cathode plate and the anode plate and attaching respective ends of the supporters to the cathode plate and the anode plate to form the field emission display device.

2. The method of claim 1, wherein the step of forming the emission layer over the patterned electrode layer further includes churning a carbon nanotube material into a paste and coating the paste on the patterned electrode layer to form a carbon nanotube layer by a screen-printing operation.

3. The method of claim 1, wherein the step of forming the emission layer over the patterned electrode layer includes directly forming a carbon nanotube layer over the patterned electrode layer.

4. The method of claim 1, wherein the step of forming the electrode layer includes forming a silver electrode layer over the substrate by a screen-printing process.

5. The method of claim 1, wherein the step of sandblasting the electrode layer to pattern the electrode layer includes using aluminum oxide particles to etch the electrode layer.

6. The method of claim 1, wherein the cathode plate and the anode plate are attached together using a frit.

7. A method of forming a field emission display device, comprising the steps of:
forming a cathode plate using the following steps:
providing a substrate;
forming an electrode layer over the substrate;
forming an emission layer over the electrode layer;
forming a photoresist layer over the emission layer;
patterning the photoresist layer;
sandblasting the electrode layer and the emission layer using the patterned photoresist layer as a mask to form a patterned electrode layer and a patterned emission layer and fog up an exposed portion of the substrate at the same time; and
removing the patterned photoresist layer to expose the patterned electrode layer and the patterned emission layer;
forming an anode plate;
providing a plurality of supporters; and
disposing the supporters between the cathode plate and the anode plate and attaching respective ends of the supporters to the cathode plate and the anode plate to form the field emission display device.

8. The method of claim 7, wherein the step of forming the emission layer over the electrode layer further includes churning a carbon nanotube material into a paste and coating the paste on the patterned electrode layer to form a carbon nanotube layer by a screen-printing process.

9. The method of claim 7, wherein the step of forming the emission layer over the electrode layer includes directly forming a carbon nanotube layer over the electrode layer.

10. The method of claim 7, wherein the step of forming the electrode layer includes forming a silver electrode layer over the substrate by a screen-printing process.

11. The method of claim 7, wherein the step of sandblasting the electrode layer and the emission layer includes using aluminum oxide particles to etch the electrode layer and the emission layer.

12. The method of claim 7, wherein the cathode plate and the anode plate are attached together using a frit.

13. A method of forming a cathode plate, comprising the steps of:
providing a substrate;
forming an electrode layer over the substrate;
forming a patterned photoresist layer over the electrode layer; and
sandblasting the electrode layer using the patterned photoresist layer as a mask to pattern the electrode layer into a plurality of cathode structures and a plurality of gate structures.

14. The method of claim 13, further comprises the steps of:
removing the patterned photoresist layer to expose the patterned electrode layer; and
churning a carbon nanotube material to form a paste and coating the paste over the patterned electrode layer by a screen-printing process to form a carbon nanotube layer that serves as an emission layer.

15. The method of claim 13, wherein the method further includes the following steps:
removing the patterned photoresist layer to expose the patterned electrode layer; and
directly forming a carbon nanotube layer on the patterned electrode layer to serve as an emission layer.

16. The method of claim 13, wherein the step of forming the electrode layer includes forming a silver electrode layer over the substrate by a screen-printing process and the step of sandblasting the electrode layer to pattern the electrode layer includes using aluminum oxide particles to etch the electrode layer.

17. A method of forming the cathode plate, comprising the steps of:
providing a substrate;
forming an electrode layer over the substrate;
forming an emission layer over the electrode layer;
forming a patterned photoresist layer over the emission layer; and
sandblasting the electrode layer and the emission layer using the patterned photoresist layer as a mask to form a patterned electrode layer and a patterned emission layer and fog up an exposed portion of the substrate, wherein the patterned electrode layer comprises a plurality of cathode structures and a plurality of gate structures, and the patterned emission layer covers the cathode structures.

18. The method of claim 17, further includes removing the patterned photoresist layer to expose the patterned electrode layer and the patterned emission layer.

19. The method of claim 17, wherein the step of forming the emission layer over the electrode layer further includes churning a carbon nanotube material into a paste and coating the paste on the electrode layer by a screen-printing process to form a carbon nanotube layer.

20. The method of claim 17, wherein the step of forming the emission layer over the electrode layer includes directly forming a carbon nanotube layer over the electrode layer.

21. The method of claim 17, wherein the step of forming the electrode layer includes forming a silver electrode layer over the substrate by a screen-printing process and the step of sandblasting the electrode layer and the emission layer includes using aluminum oxide particles to etch the electrode layer and the emission layer.
